(19) United States
(12) Patent Application Publication
(10) Pub. No.: US 2018/0036665 A1
(43) Pub. Date: Feb. 8, 2018

(54) Filter Element, in Particular for Gas Filtration

(71) Applicant: Mann+Hummel GMBH, Ludwigsburg (DE)

(72) Inventors: Torsten Fritzsching, Vaihingen (DE); Robert Hasenfratz, Waiblingen (DE); Andreas Franz, Ludwigsburg (DE); Sascha Bauer, Auenwald (DE)

(21) Appl. No.: 15/783,296

(22) Filed: Oct. 13, 2017

Related U.S. Application Data
(63) Continuation of application No. PCT/EP2016/055844, filed on Mar. 17, 2016.

(30) Foreign Application Priority Data
Apr. 15, 2015 (DE) 10 2015 004 643.8

(51) Int. Cl. B01D 46/00; F02M 35/024; B01D 46/10

(52) U.S. Cl. CPC B01D 46/0006; B01D 46/103; B01D 46/002; F02M 35/02425; B01D 2279/60; B01D 2265/025; B01D 2265/028

(57) ABSTRACT

A filter element is provided with a support body and one or more filter medium bodies arranged on the support body. One or more guide elements are arranged on the support body and guide the filter element in an insertion direction in a receiving filter housing, when the filter element is inserted in the insertion direction into the receiving filter housing. A filter device with such a filter element and a filter housing is provided. The filter housing has a counter guide element engaging the one or more guide elements of the filter element.

### CROSS-REFERENCE TO RELATED APPLICATIONS

This application is a continuation application of international application No. PCT/EP2016/055844 having an international filing date of 17 Mar. 2016 and designating the United States, the international application claiming a priority date of 15 Apr. 2015, based on prior filed German patent applications No. 10 2015 004 643.8, the entire contents of the aforesaid international application and the aforesaid German patent application being incorporated herein by reference.

### BACKGROUND OF THE INVENTION

The invention concerns a filter element, in particular for gas filtration, with at least one filter medium body that is arranged on a support body.

DE 10 2011 083 657 A1 describes a filter element for a fresh air device of a vehicle that comprises two parallelepipedal filter medium bodies that are secured on a common support body. The filter medium bodies embodied as folded filters delimit between them a clean chamber from which the purified air that flows through the filter medium bodies from the exterior to the interior is discharged axially. In the installed position, the filter element is inserted in a receiving filter housing. In this context, attention must be paid in regard to proper installation and a correct seat in the filter housing in order to avoid malfunctions and noise emissions due to vibrations.

### SUMMARY OF THE INVENTION

It is the object of the invention to provide with simple constructive measures a filter element that can be easily installed and reliably received in a filter housing.

This object is solved according to the invention in that at least one guide element for guiding the filter element in the insertion direction in a receiving filter housing is arranged on the support body.

The dependent claims provide expedient further embodiments.

The filter element according to the invention is used preferably for gas filtration, for example, for filtration of the combustion air for an internal combustion engine or for purifying fresh air which is supplied to cabins, for example, vehicle interiors. The filter element can however also be used for filtration of liquids.

The filter element comprises at least one filter medium body which is arranged on a support body wherein at least one guide element is arranged on the support body for guiding the filter element in a receiving filter housing.

The guide element serves for guiding the filter element in insertion direction within the receiving filter housing during the installation. Moreover, the guide element also performs a securing function after reaching the end position in the filter housing. The filter medium body is comprised advantageously of a folded filter medium. The filter element is configured in particular as a hollow element.

The guide element effects thus two advantages: On the one hand, the insertion of the filter element into the filter housing is simplified so that in particular large and relatively heavy filter elements, for example, for the intake manifold of a commercial vehicle, can be inserted manually into the filter housing and without risk of canting and hooking of the filter element. On the other hand, also a safe and stable position after completion of the insertion process is achieved that is maintained during operation of the filter device comprising the filter element. Vibrations, impacts, and oscillations to which the filter element is exposed during ongoing operation can thus be better absorbed by the filter element and the filter housing; at the same time, the risk of an undesirable noise development by relative movements between filter element and filter housing is reduced.

It can be expedient to arrange the guide element at a spacing to the filter medium body. This enables guiding between the guide element and the nearest section of the filter medium body. In an alternative embodiment, it can however be advantageous also that the filter medium body adjoins immediately the guide element wherein guiding is realized at the side of the guide element facing away from the filter medium body.

According to a further expedient embodiment, the guide element projects laterally past the filter medium body. This embodiment makes it possible to insert the guide element into the receiving filter housing wherein on the side of the guide element a sufficient spacing is existing between the filter medium body and the inner wall of the filter housing or a counter guide element on the inner wall. According to an alternative embodiment, it is however provided that in lateral radial direction the guide element and the filter medium body have the same length or the filter medium body is projecting farther outwardly than the guide element. In this case, a counter guide element on the inner wall of the receiving filter housing engages advantageously so far in the direction toward the filter element that a contact between the guide element on the support body of the filter element and the counter guide element on the inner wall of the filter housing is existing without impairment by the filter medium body.

According to a further expedient embodiment, the guide element is configured as a guide rail which is extending approximately or completely across the length of the filter element. The insertion direction of the filter element represents at the same time the direction of the length of the filter element. The guide rail experiences, at least essentially, during the entire insertion movement of the filter element a support action on the filter housing.

It suffices in principle to arrange a single guide rail on the support body in order to achieve a satisfactory guiding action on the filter housing. According to a further embodiment, on the other hand, two at least approximately parallel extending guide rails are arranged on the support body whereby the guiding action is improved. The guide rails can either extend completely parallel or, in an alternative embodiment, can be positioned at a small angle relative to each other in order to cause a changing resistance, for example, during the insertion movement into the filter housing. In this context, it is in particular advantageous that the resistance increases as the end position is approached so that, after reaching the filter position, a stable position is assumed by friction between the guide rails and a counter guide element on the filter housing. The friction between guide element and counter guide element can also be achieved by another configuration of the guide element and is not limited to a guide rail.

According to a further expedient embodiment, the guide element is configured as a guide rib which is extending in particular transverse to the longitudinal extension (the longitudinal axis of the insertion movement) of the filter element. The guide rib is in particular embodied U-shaped or C-shaped and interacts like a tongue and groove connection with the housing-associated counter guide element. Across the length of the filter element, in particular a plurality of guide ribs are provided on the support body in order to achieve across the length a stable support action relative to the filter housing. The individual guide ribs can have relative to each other the same spacing, respectively, or can be arranged at different spacings. Expediently, the guide ribs can be arranged parallel to each other. However, it is also possible to assign to the guide ribs a flow-conducting function, wherein number, design, and arrangement of the guide ribs on the filter element are then matched to the respective application.

According to a further expedient embodiment, the support body is configured as a support frame which is resting against one side face of the filter medium body and supports it. The support frame with longitudinal and transverse or circumferential stays with intermediate cutouts imparts stability to the filter medium body and is located preferably at the outflow or clean side of the filter medium body, even though in principle an arrangement at the inflow or raw side of the filter medium body is possible.

In a further embodiment, the support body is configured as a filter element housing in which the filter medium body is received. The filter element housing can take on a flow conducting function and can comprise, as needed, a flow space, for example, a clean chamber for receiving the purified fluid after having passed the filter medium body.

According to a further expedient embodiment, the guide element is or the guide elements are formed together with the support body as one piece. The support body is in particular embodied as a plastic component, preferably an injection molded plastic component, wherein the guide element or guide elements are injection molded onto the support body. However, an embodiment of the guide element or the guide elements separate from the support body is possible wherein the guide element(s) are fixedly connected to the support body in this case.

According to a further expedient embodiment, the filter medium body is embodied to be curved at least over sections thereof. The curvature can be embodied either concave or convex toward the exterior side of the filter element. Moreover, it is possible that the filter medium body is embodied curved across a first section and straight across a second section. However, embodiments are also possible in which the entire filter medium body is embodied to be curved. The filter element with curved filter medium bodies comprises, for example, a flattened, approximately elliptical or oval cross section or a round cross section.

The filter element is preferably configured as a hollow element, i.e., the fluid flows preferably through the filter medium body into a cavity of the filter element which serves as a clean chamber or, alternatively, from a raw-side cavity through the filter medium body to a clean side.

In a further expedient embodiment, on the support body at least two filter medium bodies are arranged which delimit between them a flow space for the fluid which is guided through the filter medium body. The intermediately positioned flow space forms in particular the clean chamber for receiving the purified fluid that is conducted from the exterior to the interior through the filter medium body. However, flow in opposite direction is possible also in which the intermediately positioned flow space forms the raw chamber for receiving the unpurified fluid which flows subsequently through the filter medium bodies from the interior to the exterior. The flow space is positioned in particular within the support body and, in an embodiment of the support body as a filter element housing, is delimited by walls of the filter element housing.

The filter element comprises, for example, an at least approximately oval cross section. The two filter medium bodies are preferably arranged at the longitudinal sides of the oval; at the narrow sides of the oval, a gap is provided between the neighboring filter medium bodies. However, embodiments with round cross section shapes and/or immediately adjoining filter medium bodies are conceivable also.

In a further expedient embodiment, on the support body a locking element is arranged which serves for locking the filter element with the filter housing. By means of the locking element, a form fit locking action opposite to the insertion direction can be achieved in the installed position in order to prevent that the filter element accidentally, for example, by vibrations, becomes detached in the receiving filter housing.

The locking element is arranged on the support body and in particular is embodied as one piece together with the support body. Alternatively, the locking element can be embodied as a separate component that is connected with the support body.

The locking element, according to a further expedient embodiment, is formed on a deformable snap hook that is arranged on the support body. The deformable snap hook extends advantageously in longitudinal direction of the filter element (this corresponds to the insertion direction into the filter housing) and can be deformed in transverse direction in order to assume the locked position with a counter element or to be released from the locked position. The snap hook projects, for example, in longitudinal direction of the filter element past the support body.

According to a further advantageous embodiment, the locking element is arranged on a deformable grip which is arranged on the support body, in particular is formed as one piece together with the support body. By the deformable grip, the filter element can be inserted into the filter housing or removed from it. In order to assume the locked position or to be released from it, the grip is elastically deformed and assumes its initial position again as soon as external forces are canceled.

A filter device which is provided with the afore described filter element comprises a filter housing that serves for receiving the filter element, wherein in the filter housing a counter guide element is arranged that engages the guide element on the support body of the filter element.

A cover is attachable to the filter housing according to an advantageous embodiment. The cover, as needed, can take on a securing function for the locking element on the support body and can secure it in its locked position. When the cover is attached, on the one hand, the receiving space in the filter housing for receiving the filter element is closed off to the exterior and, on the other hand, the locking element on the support body is safely secured in its locked position so that an accidental detachment of the filter element in the filter housing is excluded. The securing action of the locking element in the locked position is realized, for example, by means of a pin on the bottom side of the cover which is contacting immediately the locking element and blocks the elastic deformation of the locking element in this way.

The guide element or guide elements and, as needed, also the locking element are located advantageously on opposite sides on the support body of the filter element. In an alternative embodiment, it can however be sufficient to arrange only on one side of the support body one or a plurality of such guide elements and, as needed, a locking element.

### BRIEF DESCRIPTION OF THE DRAWINGS

Further advantages and expedient embodiments can be taken from the additional claims, the figure description, and the drawings.

FIG. 1 is a plan view of a filter element for gas filtration, with two slightly concavely curved filter medium bodies on a support body which comprises on opposite narrow sides guide rails for guiding the filter element in a receiving filter housing.

FIG. 2 shows a view of the narrow side of the filter element of FIG. 1.

FIG. 3 shows the filter element in a view from below.

FIG. 4 is a perspective view of the filter element.

FIG. 5 is an illustration corresponding to FIG. 4 of the filter element, partially sectioned.

FIG. 6 shows a filter device in an illustrations according to FIG. 1 with the filter element in a receiving filter housing.

FIG. 7 shows a view of the narrow side of the filter device of FIG. 6.

FIG. 8 shows the filter device of FIG. 6 in a view from below.

FIG. 9 is a perspective view of the filter device of FIG. 6.

FIG. 10 is an illustration corresponding to FIG. 9 of the filter device, partially sectioned.

FIG. 11 shows an embodiment variant of a filter element with guide ribs on opposite narrow sides of the support body.

FIG. 12 shows a view of the narrow side of the filter element of FIG. 11.

FIG. 13 shows the filter element of FIG. 11 in a view from below.

FIG. 14 is a perspective view of the filter element of FIG. 11.

FIG. 15 is an illustration corresponding to FIG. 14 of the filter element, partially sectioned.

FIG. 16 is a perspective illustration of the filter element according to FIGS. 11 to 15.

FIG. 17 is a further perspective illustration of the filter element of FIGS. 11 to 15.

FIG. 18 shows a filter device in an illustration according to FIG. 11 with the filter element of FIG. 11 in a receiving filter housing.

FIG. 19 shows a view of the narrow side of the filter device of FIG. 18.

FIG. 20 shows the filter device of FIG. 18 in a view from below.

FIG. 21 is a perspective view of the filter device of FIG. 18.

FIG. 22 is an illustration corresponding to FIG. 21 of the filter device, partially sectioned.

FIG. 23 is a detail of the filter element with a grip on the support body.

FIG. 24 shows the inner side of a cover to be attached to the filter housing.

In the Figures, same components are provided with same reference characters.

### DETAILED DESCRIPTION

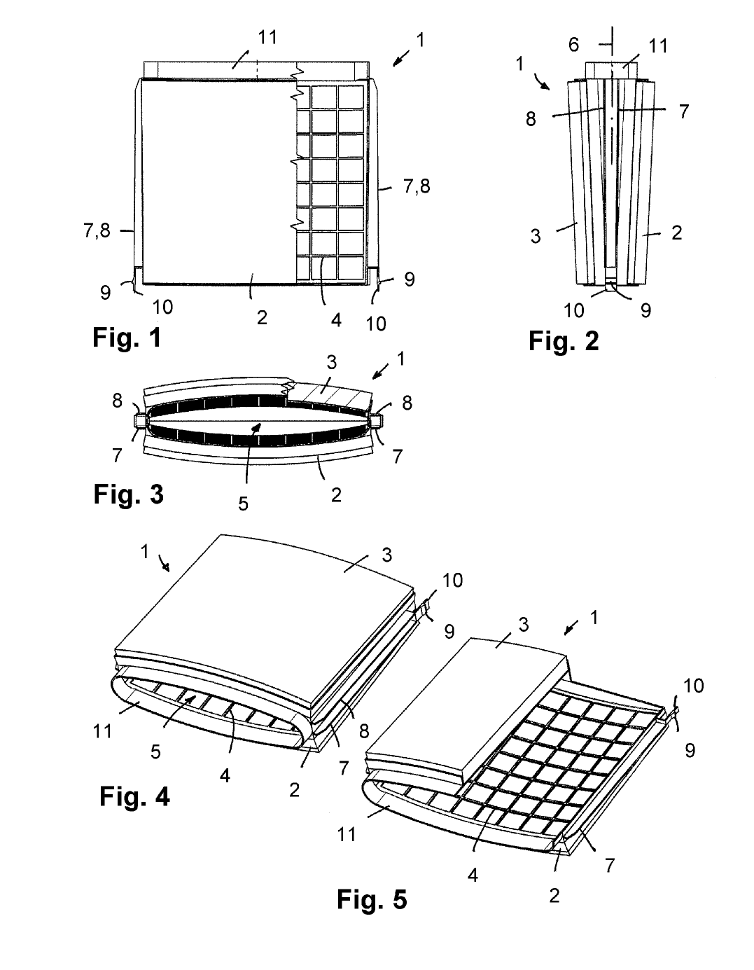

In FIGS. 1 to 5, a first embodiment of the filter element is illustrated that is used for gas filtration, in particular for filtration of the combustion air to be supplied to an internal combustion engine in a motor vehicle or commercial vehicle. The filter element 1 comprises two slightly convexly outwardly curved filter medium bodies 2, 3 which are arranged on a support body 4 formed as a support frame and enclose an intermediately positioned flow space 5 in the support body 4. The internally positioned flow space 5 forms the clean chamber in which the purified fluid collects. The two filter medium bodies 2 and 3 are flowed through from the exterior to the interior by the fluid. The discharge of the purified fluid from the flow space 5 is realized axially, relative to the longitudinal axis 6 (FIG. 2).

As can be seen in FIG. 2, the cross section of the filter element 1 widens in axial direction. The two filter medium bodies 2 and 3, relative to the longitudinal axis 6, are angularly arranged and are positioned relative to the longitudinal axis 6 at an angle of approximately 10°. In this way, on the bottom side and on the top side of the filter element 1 a differently sized extension transverse to the longitudinal axis 6 is provided.

The support body 4 comprises a non-round, flattened cross section approximating an ellipse or an oval, as can be seen in particular in FIGS. 3 to 5. Correspondingly, the filter element 1 with the convexly outwardly curved filter medium bodies 2 and 3, arranged on the exterior side of the support body 4 and located respectively on the longitudinal sides of the support body 4, also has a non-round, approximately elliptical or oval cross section.

In the area of the narrow sides of the filter element 1, guide rails 7 and 8, integral with the support body 4 which is preferably embodied as an injection molded plastic component, are arranged which extend relative to the longitudinal axis 6 in axial direction. Two guide rails 7, 8 are arranged, respectively, on both diametrically opposed narrow sides. The guide rails 7, 8 extend approximately parallel to each other; they assume, as can be seen in FIG. 2, relative to each other a small angle that is smaller than 10°, for example, maximally 5°.

The guide rails 7 and 8 on opposed narrow sides of the support body 4 project laterally past the support body 4 as well as past the filter medium bodies 2 and 3. The guide rails 7, 8 form guide elements by means of which the filter element is guided and supported on counter guide elements on the inner wall of the receiving filter housing. During installation, the filter element 1 is inserted into the receiving filter housing; in doing so, the guide rails 7, 8 come into contact with the counter guide elements on the inner wall of the filter housing and are subjected during the insertion movement to a guiding action on both opposite end faces. The guide rails 7, 8 extend approximately across the axial length of the support body 4 and enable in this way a guiding action on the counter guide elements in the filter housing during the entire insertion movement.

The small angle at which the two guide rails 7, 8 at an end face are positioned relative to each other enable clamping of the filter element 1 in the receiving filter housing as soon as the filter element 1 has reached its final position. At the beginning of the insertion movement into the filter housing, there is sufficient clearance between the guide rails 7, 8 and the counter guide elements on the inner housing side. With advancing insertion movement, the clearance is reduced and the laterally acting forces between guide rails and counter guide elements is increased and, accordingly, a frictional force that is holding the guide element in its position is built up.

On the axial end face, in axial extension of the guide rails 7, 8, a locking element 9 is located on the support body 4 and is arranged on a snap hook 10. The snap hook 10 can be elastically deformed in transverse direction, transverse to the longitudinal axis 6. This makes it possible to lock the locking element 9 in the end position of the filter element 1 in the filter housing with a counter locking element on the filter housing so that in the direction of the longitudinal axis 6, in particular opposite to the insertion direction, a form fit locking action is provided. The locked position is assumed in that the snap hook 10 during the insertion movement is slightly elastically deformed and in the end position assumes again its initial position in which the locking element 9 is in its locked position.

On both opposed narrow sides, a snap hook 10 with locking element 9 arranged thereat is provided, respectively.

On the end face which is positioned axially opposite the snap hooks 10, a circumferentially extending socket 11 is provided which is formed as one piece together with the support body 4 and which is projecting axially past the support body as well as the filter medium bodies 2, 3. In installed position, the socket 11 interacts with a housing-associated sealing element; by means of the socket 11, the axial outflow of the purified fluid received in the flow space 5 is realized.

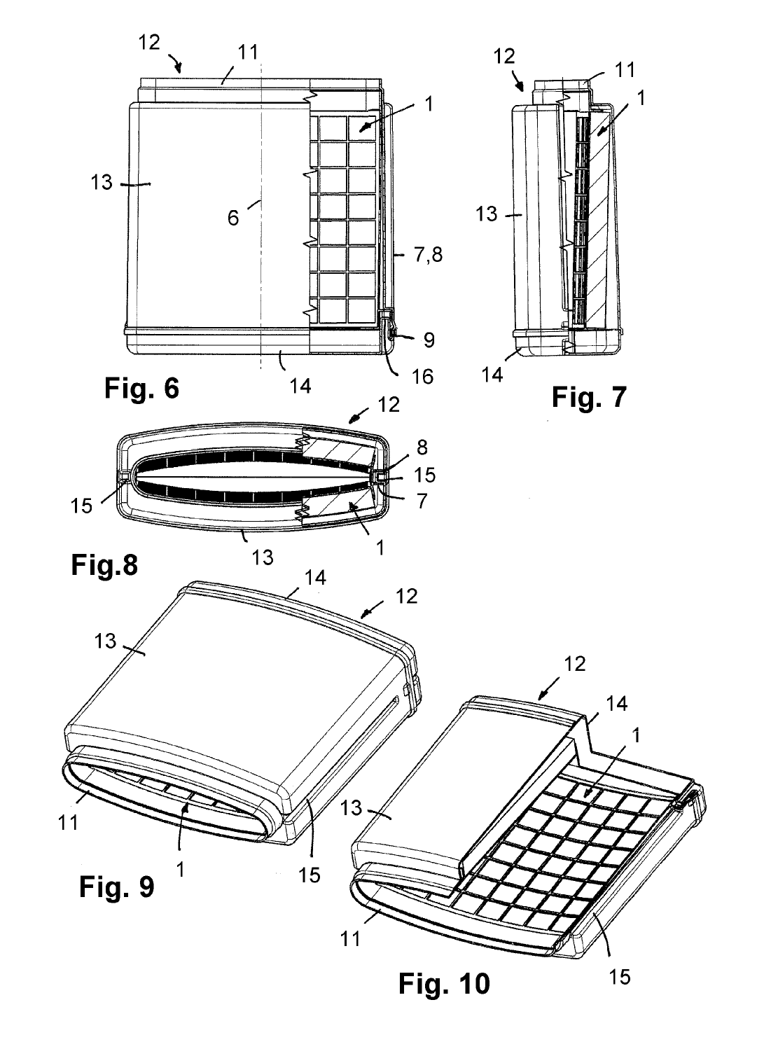

In FIGS. 6 to 10, a filter device 12 with the filter element 1 according to FIGS. 1 to 5 arranged in a receiving filter housing 13 provided with a cover 14 is illustrated. The socket 11 on the support body of the filter element 1 projects axially from the receiving filter housing 13. In the area of the narrow sides, on the filter housing 13 an inwardly oriented projection 15 is provided on both opposite sides of the filter housing and is projecting into the intermediate space between the two approximately parallel extending guide rails 7 and 8 at the narrow side of the support body 4. The projection 15 forms the counter guide element for guiding and securing the filter element 1 in the filter housing 13. During installation, the filter element 1, with the socket 11 leading, is inserted into the receiving filter housing 13.

On the side which is facing the socket 11, the adjacently extending guide rails 7 and 8 have a greater spacing relative to each other than on the opposite side so that the beginning of the insertion movement along the projection 15, which has across its axial length a constant width, is realized with only minimal or no friction. The farther the filter element 1 is inserted into the filter housing 13, the more the spacing between the guide rails 7 and 8 narrows so that the guide rails come into immediate contact with the projection 15 and a corresponding frictional force is built up.

In the final position, the socket 11 which is arranged on the support body 4 projects through a bottom-side cutout in the filter housing 13. On the opposite side, the cover 14 can be attached to the filter housing 13. The locking element 9 on the snap hook which is arranged on the support body 4 reaches in end position of the filter element a locked position with a housing-associated counter locking element. This counter locking element, as needed, can be formed by the open end face of the filter housing 13. However, it is also possible to provide on the inner wall of the filter housing a corresponding counter locking element in which the locking element 9 on the support body 4 is locked.

For securing the locked position, a pin-shaped or peg-shaped projection 16 is provided on the inner cover side and is contacting immediately the snap hook 10 and prevents in this way an elastic transverse movement of the snap hook 10 with which the snap hook 10 and the locking element 9 could reach a disengaged position. The projection 16 on the inner cover side secures thus the locked position of the filter element 1.

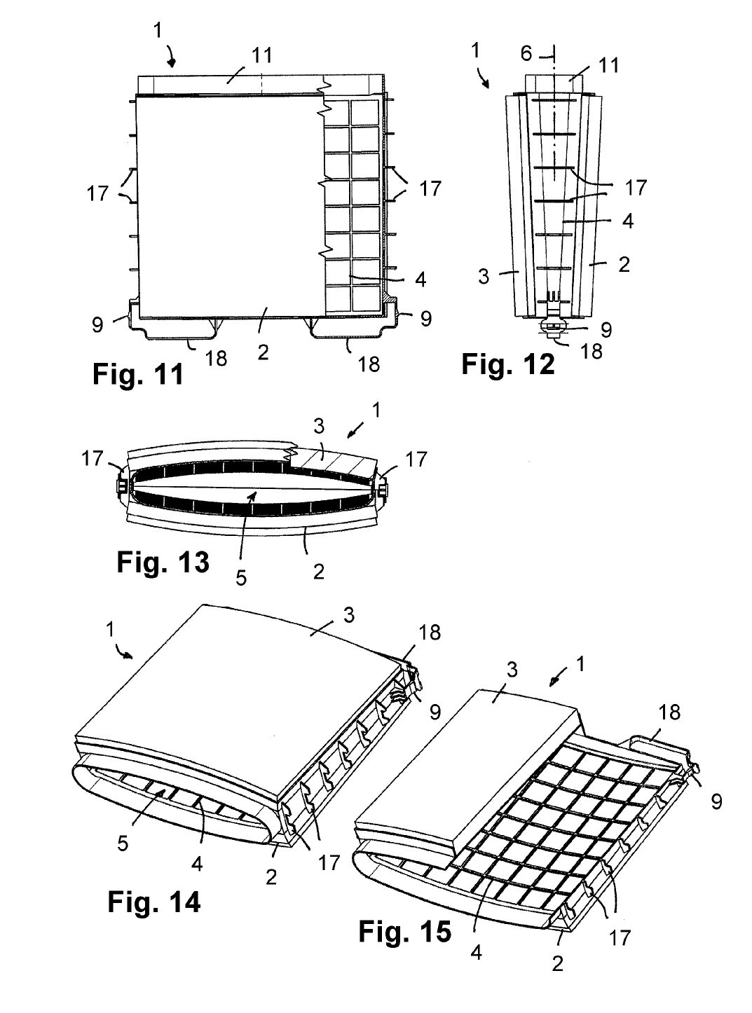

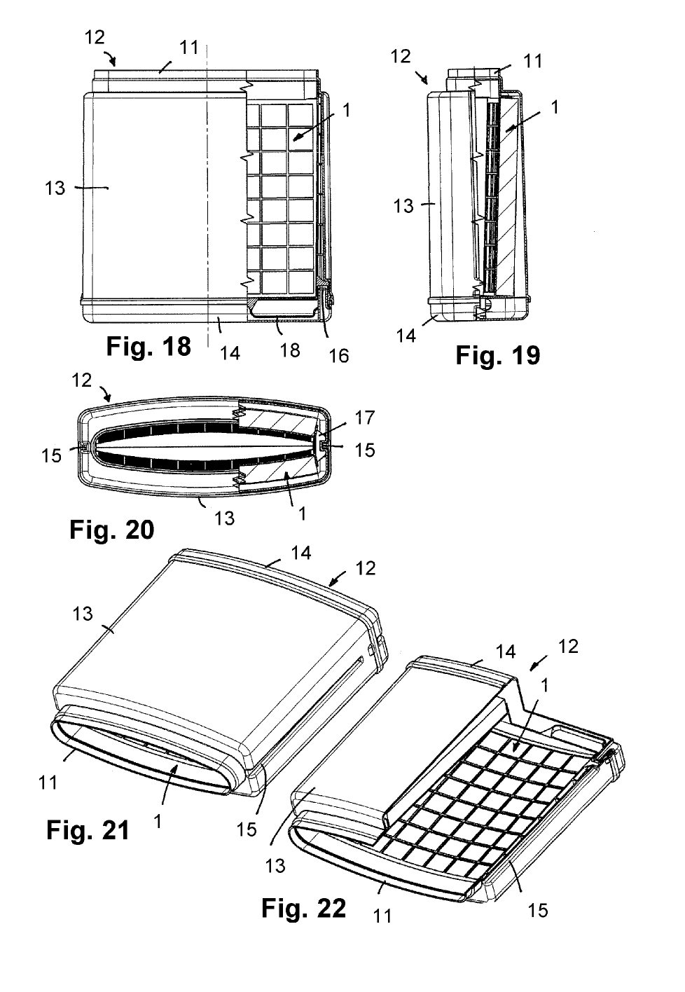

FIGS. 11 to 17 show a filter element 1 in an embodiment variant; FIGS. 18 to 22 show a filter device 12 with a corresponding filter element 1. The configuration of the filter element 1 with two slightly convexly outwardly curved filter medium bodies 2 and 3 on the longitudinal sides of a support body 4, embodied as a support frame and exhibiting an approximately elliptical or oval cross section, corresponds to that of the first embodiment.

On the opposite narrow sides, guide ribs 17 that are embodied U-shaped or C-shaped are provided on the support body 4 as guide elements. Distributed across the axial length, a plurality of parallel arranged guide ribs 17 are arranged on each narrow side of the support body 4. Into the intermediate space between the guide ribs 17, the inwardly oriented projection 15 on the filter housing 13 is projecting in the mounted state. Since across the axial length a plurality of guide ribs 17 are arranged on the support body of the filter element 1, a guiding action on the projection 15 is accordingly also ensured across the axial length of the filter element.

On the side which is opposite the socket 11, two grips 18 are arranged on the support body 4 which are formed as one piece together with the support body. On the exterior sides of each grip 18, a locking element 9 is integrally formed which, in the mounted state, is preferably resting on the free end face of the filter housing 13 in a locked position. The grips 18 can elastically deform so that the locked position is reached by the deformation and the locked position itself, in which the filter element 1 is secured against accidental axial detachment from the filter housing 13, is reliably maintained.

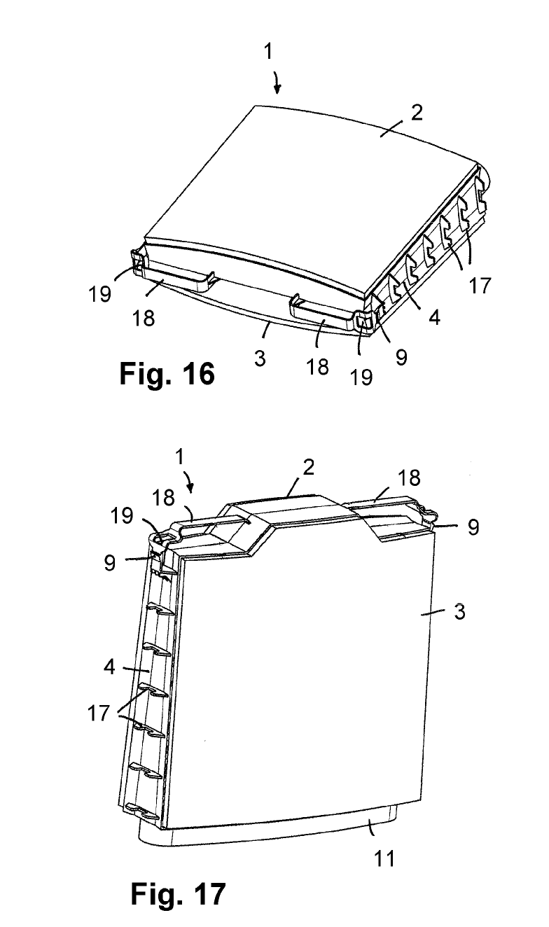

As can be seen in particular in FIGS. 16 and 17, in each grip 18 adjacent to its exterior side a recess 19 is introduced which is neighboring the locking element 9. When the cover 14 is attached, the projection 16 on the inner cover side (FIG. 18) projects into the recess 19 in the grip 18 and prevents in this way that the grip 18 elastically deforms and the locking element 9 accidentally reaches the disengaged position. When the cover 14 is attached, a reliable non-detachable locking action is ensured.

For removing the filter element 1, the cover 14 is removed, subsequently the filter element 1 is lifted out of the filter housing 13 by the grips 18. In doing so, the grips 18 can elastically deform so that the locking element 9 reaches the disengaged position and removal of the filter element 1 from the filter housing is enabled.

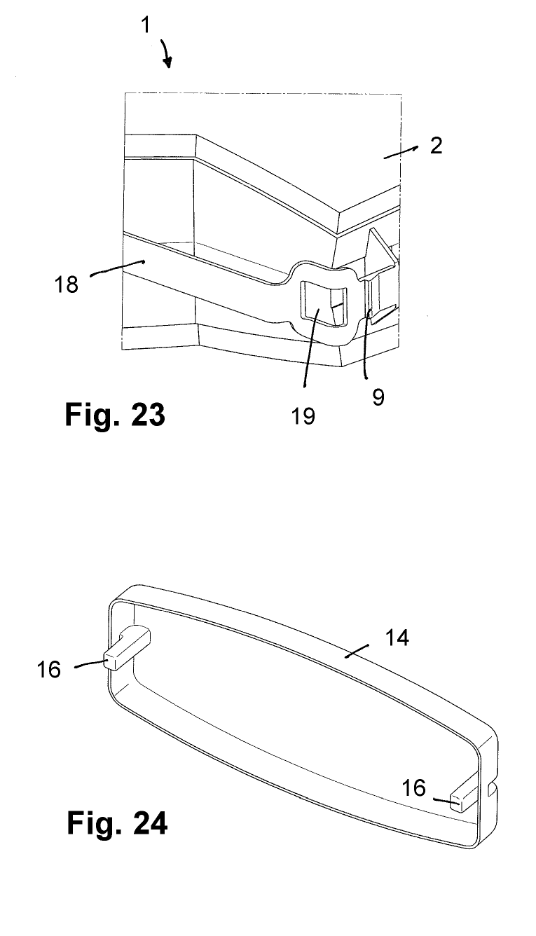

In FIG. 23, the recess 19 in the grip 18 which is formed integrally on the support body is shown in enlarged illustration. The recess 19 extends across the rim area of the grip 18 and thus partially into the lateral area in which also the locking element 9 is located on the grip 18 and partially into the upwardly positioned area on the end face of the filter element. The greater section of the recess 19 is positioned in the upper end face area. The recess 19 has a square or slightly rectangular cross section.

As can be seen in the inside view of the cover 14 according to FIG. 24, the pin-shaped projections 16, which project into the recesses 19 when the cover is attached, are positioned on opposite narrow sides of the cover. The projections 16 project axially past the lower cover rim. The projections 16 have a cross section matched to the recess 19; in the embodiment, the cross section of the projections 16 is square or slightly rectangular.

What is claimed is:

1. A filter element comprising:
a support body;
one or more filter medium bodies arranged on the support body;
one or more guide elements arranged on the support body and configured to guide the filter element in an insertion direction in a receiving filter housing, when inserting the filter element in the insertion direction into the receiving filter housing.

2. The filter element according to claim 1, wherein the one or more guide elements laterally project past the one or more filter medium bodies.

3. The filter element according to claim 1, wherein the one or more guide elements extend laterally no farther outwardly than the one or more filter medium bodies.

4. The filter element according to claim 1, wherein the one or more guide elements include one or more guide rails which extends approximately across or completely across a length of the filter element.

5. The filter element according to claim 4, wherein two of the guide rails are arranged on the support body and extend parallel or approximately parallel to each other.

6. The filter element according to claim 1, wherein the one or more guide elements include one or more guide ribs extending transversely to a longitudinal extension of the filter element, wherein the one or more guide ribs are configure to interact with a counter guide element of the receiving filter housing in a tongue and groove interaction.

7. The filter element according to claim 6, wherein the one or more guide ribs are U-shaped.

8. The filter element according to claim 1, wherein the one or more filter medium bodies are curved at least over sections thereof.

9. The filter element according to claim 1, wherein the one or more filter medium bodies include two filter medium bodies arranged on the support body so as to delimit an intermediately positioned flow space for a fluid.

10. The filter element according to claim 1, further comprising a locking element arranged on the support body and configured to lock the filter element with the filter housing.

11. The filter element according to claim 10, further comprising a deformable snap hook arranged on the support body, wherein the locking element is formed on the deformable snap hook.

12. The filter element according to claim 10, further comprising a deformable grip arranged on the support body, wherein the locking element is formed on the deformable grip.

13. A filter device comprising:
a filter element comprising a support body and one or more filter medium bodies arranged on the support body;
a filter housing configured to receive the filter element;
the filter element comprising one or more guide elements arranged on the support body and configured to guide the filter element in an insertion direction into the filter housing;
the filter housing comprising a counter guide element engaging the one or more guide elements arranged on the support body of the filter element.

14. The filter device according to claim 13, further comprising a cover attachable to the filter housing and, when attached to the filter housing, securing a locking element arranged on the support body in a locked position on the filter housing.

15. The filter device according to claim 14, wherein on an inner side of the cover a projection is arranged, wherein the projection is resting against the locking element and secures the locking element in the locked position on the filter housing.
